(19) United States
(12) Patent Application Publication
(10) Pub. No.: US 2008/0106060 A1
(43) Pub. Date: May 8, 2008

(54) Wheelchair with two-stage tilt

(75) Inventor: Michael Knopf, Dielheim (DE)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Sunrise Medical GmbH & Co. KG

(21) Appl. No.: 11/982,931

(22) Filed: Nov. 6, 2007

Related U.S. Application Data
(60) Provisional application No. 60/856,950, filed on Nov. 6, 2006.

(30) Foreign Application Priority Data
Oct. 15, 2007 (EP) EP 07020110.8
Oct. 15, 2007 (EP) EP 07020111.6
Oct. 15, 2007 (EP) EP 07020112.4

(51) Int. Cl. B62M 1/14

(52) U.S. Cl. 280/250.1

(57) ABSTRACT

A wheelchair having a two-stage tilt ability is provided. The wheelchair includes a base frame and a seat mounted to the base frame. The seat is configured for rearward tilting. A mounting mechanism is connected to the seat. The mounting mechanism is configured to tilt the seat by a first pivoting of the seat through a first range of tilting about a first pivot axis and a second pivoting of the seat through a second range of tilting about a second pivot axis.

### RELATED APPLICATIONS

This application claims priority from U.S. Provisional Patent Application Ser. No. 60/856,950, filed Nov. 6, 2006, entitled MANUAL WHEELCHAIR, from European Patent Application No. EP 07020111.6 filed Oct. 15, 2007, entitled PERSONAL MOBILITY VEHICLE WITH TWO STAGE TILT ABILITY AND METHOD FOR REARWARD TILTING A SEAT, from European Patent Application No. EP 07020110.8 filed Oct. 15, 2007, entitled PERSONAL MOBILITY VEHICLE WITH MOVABLE REAR CASTER WHEEL AND METHOD FOR MOVING A REAR CASTER WHEEL, from European Patent Application No. EP 07020112.4 filed Oct. 15, 2007, entitled PERSONAL MOBILITY VEHICLE, the disclosures of which are incorporated herein by reference.

### TECHNICAL FIELD

This invention relates to a wheelchair of the type useful for elderly and handicapped people. More particularly, the invention relates to a wheelchair capable of tilting.

### BACKGROUND OF THE INVENTION

A wheelchair is typically used by individuals requiring assistance with their mobility due to a physical limitation or disability. Examples of a wheelchair include manual wheelchairs and powered wheelchairs. Wheelchairs typically have a drive wheel, or plurality of drive wheels, attached to a frame. A seat is attached to the frame and supports the rider. The frame is also typically supported by a fixed wheel or a plurality of fixed wheels, such as caster wheels or anti-tip wheels. It would be advantageous if wheelchairs could be improved to make them be easily adapted to the needs of an occupant and enhance the overall flexibility.

### SUMMARY OF THE INVENTION

According to this invention there is provided a wheelchair having a two-stage tilt ability. The wheelchair includes a base frame and a seat mounted to the base frame. The seat is configured for rearward tilting. A mounting mechanism is connected to the seat. The mounting mechanism is configured to tilt the seat by a first pivoting of the seat through a first range of tilting about a first pivot axis and a second pivoting of the seat through a second range of tilting about a second pivot axis.

According to this invention there is also provided a method for tilting a seat of a wheelchair. The method includes a first pivoting of the seat through a first range of tilting, the first pivoting being about a first pivot point, and a second pivoting of the seat through a second range of tilting, the second tilting being about a second pivot point.

According to this invention there is also provided a wheelchair including a base frame and a seat mounted to the base frame. One or more rear caster wheels are supported by at least one caster arm. The caster arm is configured to move with respect to the base frame. A locking mechanism is configured to adjustably secure the caster arm in a desired position. Each position of the caster arm maintains the rear caster wheel at a specified position relative to a supporting surface of the wheelchair. The locking mechanism comprises at least one first biasing device configured to force the caster arm into at least one first position.

According to this invention there is also provided a wheelchair having a base frame including at least one drive device and at least one seat carrying frame. The base frame includes at least one pair of separate base frame members mounted at opposite sides to the seat carrying frame. Each of the base frame members is detachably mounted via at least one interchangeable spacer to the seat carrying frame.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic side view illustrating a wheelchair having a seat in an upright tilt position.

FIG. 2 is a schematic side view of a tilting mechanism of the wheelchair of FIG. 1.

FIG. 3 is a schematic side view of the tilting mechanism of FIG. 2 in a first tilted position.

FIG. 4 is a schematic side view of the tilting mechanism of FIG. 2 in a second tilted position.

FIG. 5 is a schematic view the operating device of the wheelchair of FIG. 1.

FIG. 6 is a schematic side view of an alternate embodiment of the tilting mechanism of the wheelchair of FIG. 1.

FIG. 7 is a schematic side view of the tilting mechanism of FIG. 6 in a first tilted position.

FIG. 8 is a side schematic view of a rear caster wheel of the wheelchair of FIG. 1.

FIG. 9 is a side schematic view of a rear caster wheel of FIG. 8 in a first raised position.

FIG. 10 is a side schematic view of the rear caster wheel of FIG. 8 in a second raised position.

FIG. 11 is a side schematic view of a second embodiment of the rear caster wheel shown in a first position.

FIG. 12 is a side schematic view of the rear caster wheel of FIG. 11 shown in a second position.

FIG. 13 is a side perspective view of another embodiment of the wheelchair illustrating a modular base frame.

FIG. 14 is a top perspective view of the wheelchair of FIG. 13.

### DETAILED DESCRIPTION OF THE INVENTION

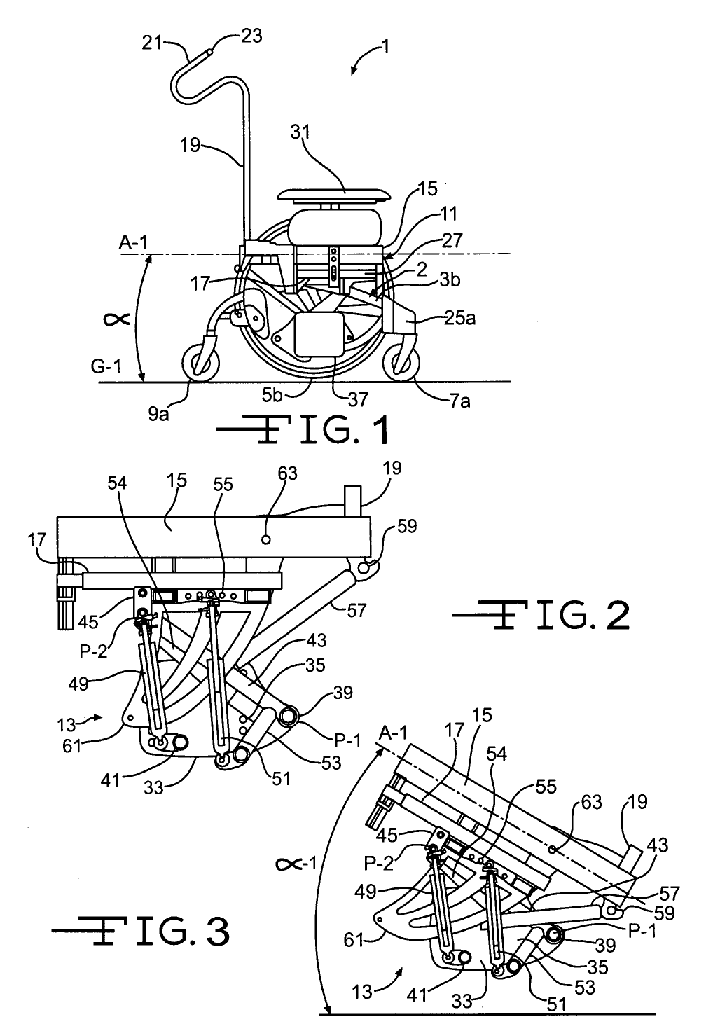

The description and drawings disclose a wheelchair for assisting individuals with their mobility due to a physical limitation or disability. One embodiment of the wheelchair, indicated generally at 1, is shown in FIG. 1. The wheelchair 1 includes a base frame 2. The base frame 2 has a pair of base frame members, 3a and 3b. Each of the base frame members 3a and 3b, is configured to support opposing primary support wheels 5a and 5b, front caster wheels 7a and 7b and rear caster wheels 9a and 9b. For purposes of clarity, only primary support wheel 5b, front caster wheel 7a and rear caster wheel 9a are shown in FIG. 1. For purposes of orientation, members 3a, 5a, 7a and 9a are associated with the right side of the wheelchair 1, and the respective complementary members 3b, 5b, 7b and 9b are associated with the left side of the wheelchair 1.

In the illustrated embodiment, the primary support wheels 5a and 5b are centrally arranged on the base frame members 3a and 3b. Referring again to FIG. 1, the base frame members 3a and 3b are connected to a seat carrying frame 11 as will be explained below in more detail. The seat carrying frame 11 includes a mounting mechanism having a tilt frame 13. The mounting mechanism is configured to allow a two-stage tilting of a seat 15 with respect to the base frame 2. The seat 15 includes a seat frame member 17 defining a seating area and a backrest 19. In one embodiment, the wheelchair 1 can be maneuvered by a handle 21. In the illustrated embodiment, the handle 21 includes an operating device for the mounting mechanism in the form of a rotating grip 23. Alternatively, the operating device can be another mechanism or device, located in another position on the wheelchair, sufficient to operate the mounting mechanism.

Referring again to FIG. 1, the front caster wheels 7a, 7b are connected to the respective base frame member 3a and 3b via suspension systems 25a and 25b (only 25a is illustrated). The tilt frame 13 includes actuation members 27 and 29 (only 27 is shown) configured to allow tilting of the seat frame element 17 with respect to the base frame members 3a, 3b. The actuation members 27 and 29 are also configured to allow a pivoting of the backrest 19 with respect to the seat frame member 17. In the illustrated embodiment, the actuation members 27 and 29 are gas springs. Alternatively, the actuation members 27 and 29 can be other devices or mechanisms, such as for example hydraulic dampers, sufficient to allow tilting of the seat frame element 17 with respect to the base frame members 3a and 3b, and also sufficient to allow a pivoting of the backrest 19 with respect to the seat frame member 17.

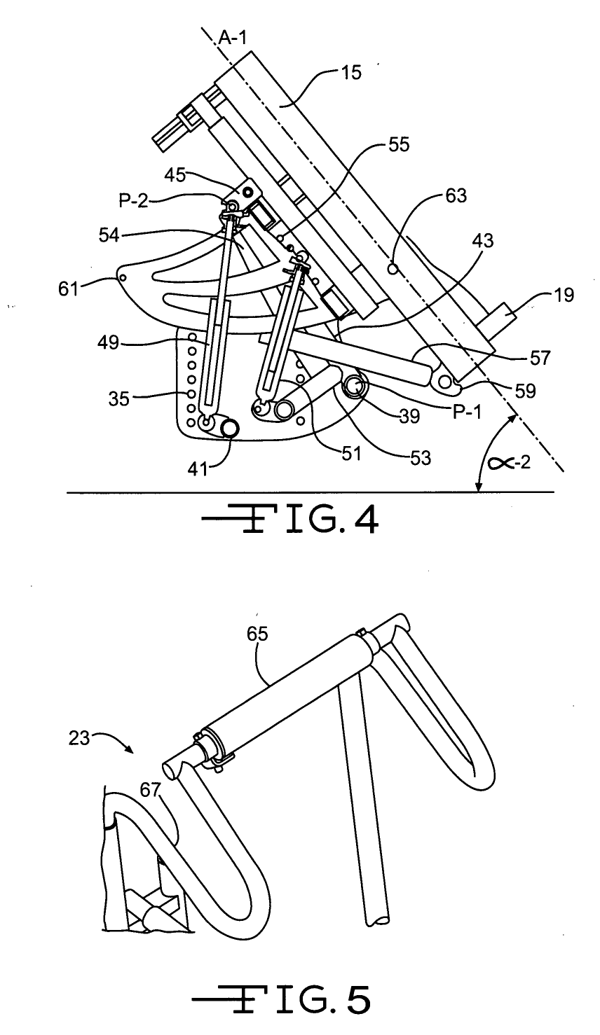

FIGS. 1-4 illustrate the two-stage tilting of the seat 15 with respect to the base frame 2. For purposes of clarity, base frame member 3a and primary support wheel 5a are not shown. In the illustrated embodiment, an armrest 31 is mounted to seat 15. As shown in FIG. 1, an axis A-1 extends along the length of the seat 15. The axis A-1 forms a tilt angle α with a generally horizontal line, such as for example a substantially level ground line G-1. As shown in FIG. 1, seat 15 is illustrated in a position in which the seat frame member 17 is in a normal, generally horizontal position corresponding to a tilt angle α of about 0°. As shown in FIG. 3, the seat frame member 17 has been tilted by an actuation member to form a first tilting step. The first tilting step corresponds to a first tilt angle α-1. In the illustrated embodiment, the first tilt angle α-1 is approximately 30°. Alternatively, the first tilt angle α-1 can be more or less than 30°. Referring now to FIG. 4, the seat frame member 17 can be tilted from the position shown in FIG. 3 into a second tilt angle α-2 in a second tilting step by a second actuation member. In the illustrated embodiment, the second tilt angle α-2 is approximately 50°. In another embodiment, the second tilt angle α-2 can be more or less than 50°.

As shown in FIG. 1, the wheelchair 1 includes a tilt frame plate 37. As shown in FIGS. 2-4, the tilt frame 13 includes a tilt frame plate 33. The tilt frame plate 33 includes a plurality of openings 35 to connect the tilt frame 13, as being a part of the seat carrying frame 11, to the base frame members 3a, 3b. In the illustrated embodiment, the tilt frame 13 is connected to the base frame members 3a and 3b by screws. Alternatively, the tilt frame 13 can be connected to the base frame members 3a and 3b by other fasteners, such as for example, bolts, pins, clamps, or clips. The openings 35 are configured to adjust the height of the seat carrying frame 11 and/or tilt frame 13 with respect to the base frame members 3a and 3b and correspondingly with respect to a supporting surface of the wheelchair 1.

For purposes of clarity, the tilt frame plate 37 shown in FIG. 1 is not shown in FIGS. 2-4. In the illustrated embodiment, the tilt frame plates 33 and 37 are connected to each other by a first tilt frame rod 39 and a second tilt frame rod 41. Alternatively, the tilt frame plates 33 and 37 can be connected to each other by other suitable devices, mechanisms or connectors. The tilt frame 13 also includes a tilt frame strut 43. The tilt frame strut 43 is pivotable around first pivot axis P-1 defined by the first tilt frame rod 39. Seat frame member 17 is indirectly connected to the tilt frame strut 43 via a connecting element 45 and is pivotable with respect to the tilt frame strut 43 about a second pivot axis P-2.

Referring again to FIGS. 2-4, the seat frame member 17 is also connected to the tilt frame plate 33 by a first actuation member 49 and second actuation member 51. In the illustrated embodiment, the first actuation member 49 and the second actuation member 51 are gas springs. Alternatively, the seat frame member 17 can be connected to the tilt frame plate 33 by other suitable mechanisms or devices. The second actuation member 51 is connected to the seat frame 17 and to the tilt frame strut 43 by an extension 53. To increase the rigidity of tilt frame strut 43 and to further fix the extension 53 with respect to tilt frame strut 43, both the extension 53 and the tilt frame strut 43 are connected to a reinforcement sheet 54.

As shown in FIG. 2, second actuation member 51 can be mounted to the seat frame member 17 at different positions represented by respective apertures 55. The respective apertures 55 are configured to adapt the mounting mechanism to the respective needs of an occupant of the wheelchair 1. One example of an occupant need is an adaptation to a weight of the wheelchair occupant. In the illustrated embodiment, the second actuation member 51 is connected to the seat frame member 17 by a screw connection extending through a respective aperture 55. Alternatively, the second actuation member 51 can be connected to the seat frame member 17 by other suitable mechanisms or devices, such as for example bolts, pins, clamps or clips. It can be seen that by selecting a respective aperture 55, a distance is provided between a connection point at one of the apertures 55 of the second actuation member 51 with the seat frame member 17 and the second pivot axis P-2 and accordingly a lever arm for the second actuation member 51 may be altered.

In operation, the seat frame member 17 is tilted from the position shown in FIG. 2 in a first tilt step to the position shown in FIG. 3 by actuation of the second actuation member 51. By the reduction of the length of second actuation member 51, the seat frame member 17 is rotated about the second pivot axis P-2. Accordingly, second pivot axis P-2 defines a tilt center point for a tilt angle α-1 in a range from about 0° to about 30°. During this first pivoting of the seat 15, the tilt frame strut 43 remains mainly in one and the same position. In the illustrated embodiment, the second actuation member 51 is actuated by rotating grip 23. As can be seen in FIG. 3, since the second pivot axis P-2 is located in the forward half of the seat frame member 17, the front edge of seat frame member 17 and thus of seat 15 is raised only a small vertical distance. Accordingly, an occupant of the wheelchair 1 can tilt the seat 15 when sitting at a table, since a tilting of the seat 15 into the position shown in FIG. 3 will not normally lead to a contact of the knees of the occupant with the table.

As best shown in FIG. 4, in the event a further tilting of seat 15 or seat frame member 17 is desired, the first actuation member 49 is operated. By increasing the length of the first actuation member 49, the tilt frame strut 43 is rotated about the first pivot axis P-1. Accordingly, the first pivot axis P-1, defined by tilt frame rod 39, represents the tilt center point for a tilt angle in a range from about 30° to about 50°. As can be seen by a comparison of FIGS. 3 and 4, increasing of the length of first actuation member 49 leads to a further tilting of seat frame member 17 with respect to the base frame members 3a and 3b, and accordingly with respect to a supporting surface of the wheelchair 1.

In summary, the mounting mechanism of wheelchair 1 allows a two-stage tilting of seat 15 such that a tilting of seat 15 can occur over a wide tilt angle α. For example, a first tilt angle α-1, in a range from about 0° to about 30°, is possible by actuating the second actuation member 51. After reaching a first tilt angle α-1 of about 30°, the first actuation member 49 may be actuated to tilt the seat 15 to a second tilt angle α-2 of about, for example, 50°. To actuate the second actuation member 51, the rotatable grip 23 is turned. After a first tilt angle α-1 of about 30° is reached, the first actuation member 49 is actuated to allow a tilting of the seat 15 to about 50°. To return to a tilt angle of 0°, rotating the grip 23 actuates the first actuation member 49 to return to about 30°, before the second actuation member 51 pushes the seat to a tilt angle α of about 0°. This embodiment allows a first tilt angle α-1 of about 30° without interference with the arm pad or the arm rest 31, the rear wheels 9a and 9b, or the primary support wheels 5a and 5b. In other embodiments, other rearward tilt angle α ranges can be used.

As further shown in FIGS. 2-4, seat 15 includes a third actuation member 57. In the illustrated embodiment, the third actuation member 57 is a gas spring. Alternatively, the third actuation member 57 can be another suitable device or mechanism, such as for example a hydraulic actuator. The third actuation member 57 is connected to the backrest 19 at a connection point 59. In the illustrated embodiment, the connection is a snap-in connection. In other embodiments, the connection can be other suitable devices or mechanisms, such as for example clips, clamps or pins. The snap-in connection is configured to allow the backrest 19 to be moved manually about the pivot axis 63, for example to fold the seat 15 together. The snap-in connection can be released and the backrest 19 can be pivoted without the necessity of actuating third actuation member 57. The third actuation member 57 is connected to seat frame member 17 via a connecting element 61. The backrest 19 can be pivoted about pivot point 63 by actuating the third actuation member 57.

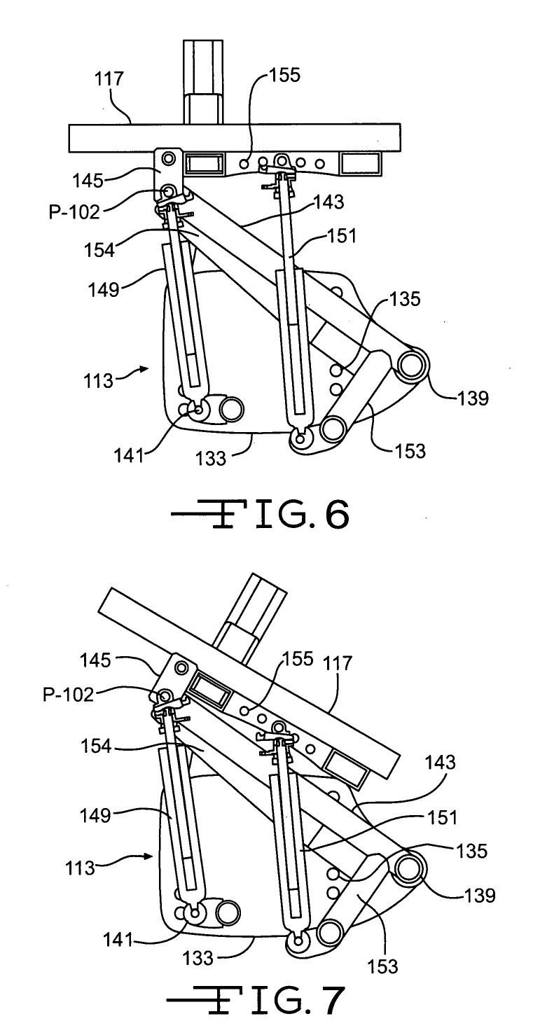

Referring now to FIG. 5, the rotating grip 23 is shown in detail. The rotating grip 23 includes a first operating device 65 and an actuation member (not shown). In general, the first operating device 65 communicates with the first actuation member 49 and the second actuation member 51 via the actuation member. The actuation member is configured to actuate the first actuation member 49 and the second actuation cable 51 when the first operating device 65 is rotated. In one embodiment, the actuation member is a cable. Alternatively, the actuation member can be other devices or mechanisms, such as for example a hydraulic or electric system sufficient to actuate the first actuation member 49 and the second actuation member 51 when the first operating device 65 is rotated. When the first operating device 65 is rotated in a first rotating range, the second actuation member 51 is actuated by the actuation member until the second actuation member 51 reaches a first operating position. The first operating position corresponds to the tilt angle α-1 shown in FIG. 3. By further rotating the first operating device 65, the first actuation member 49 is actuated, by the actuation member, leading to a further tilting of seat 15, until the tilt angle α-2 shown in FIG. 4 is reached. To return the seat 15 to the tilt angle α shown in FIG. 2, the operating device 65 is rotated in an opposite direction until the first actuation member 49 reaches a pre-determined second operating position corresponding to the tilt angle α-1 shown in FIG. 3. By further rotating the operating device 65 in the opposite direction, the second actuation member 51 is actuated so that the tilt angle α shown in FIG. 2 is reached. In one embodiment, rotating grip 23 also includes an operating device 67 for actuating the third actuation member 57 and another operating device 69 to actuate a wheelchair brake (not shown). In another embodiment, the first actuation member 49 and the second actuation member 51 can be actuated by other mechanisms or devices, such as for example electric solenoids or motors.

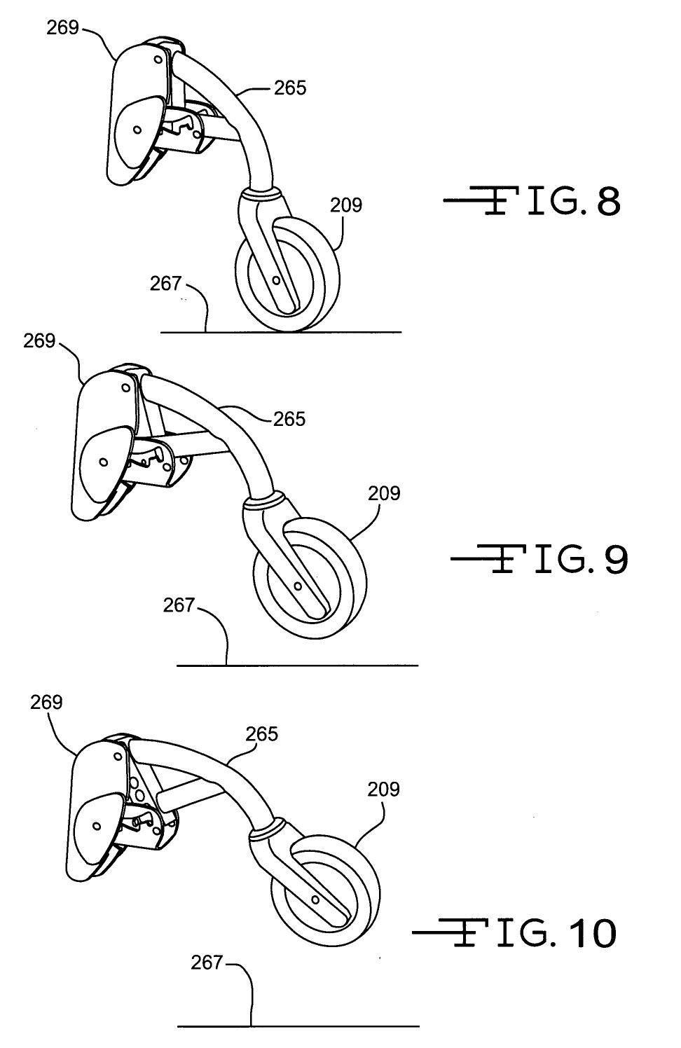

Another embodiment of a wheelchair, indicated generally at 101 is shown in FIGS. 6 and 7. Elements corresponding to respective elements of wheelchair 1 have the same reference numbers but have been increased by 100. The functionality of the mounting mechanism of wheelchair 101 corresponds to the functionality of the mounting mechanism of wheelchair 1. In a manner similar to wheelchair 1, wheelchair 101 also allows a two-stage tilting of seat 115. Generally, the wheelchair 101 differs from mounting mechanism of wheelchair 1 only in that it does not include a separate actuation member to move a backrest 119 of wheelchair 101. FIG. 6 illustrates wheelchair 101 in a normal tilt angle α with the seat 115 having a tilt angle α of about 0°. The wheelchair 101 illustrated in FIG. 7 is shown in a first tilt angle α-101 after a first tilting, for example to 30°, backward. In another embodiment, the wheelchair 101 can be further tilted to larger tilt angles, such as for example about 50°.

In another embodiment, a wheelchair can include releasable rear caster wheels. In this embodiment, the releasable rear caster wheels are configured to provide rear anti-tip wheels when the wheelchair includes a primary support wheel located approximately at the center of gravity of an occupant of the wheelchair. The releasable rear caster wheels are also advantageous when overriding an obstacle with the wheelchair. In this embodiment, the distance from the releasable rear caster wheels to a supporting surface can be adjusted, thereby allowing a tipping back of the wheelchair within pre-determined limits. Accordingly, in one embodiment, the releasable rear caster wheel is configured in a first position allowing the wheel to override an object, such as for example a road curb. The releasable rear caster wheel is configured to be locked in a second position, wherein the wheel is in contact with the ground when no obstacle is required to be overridden.

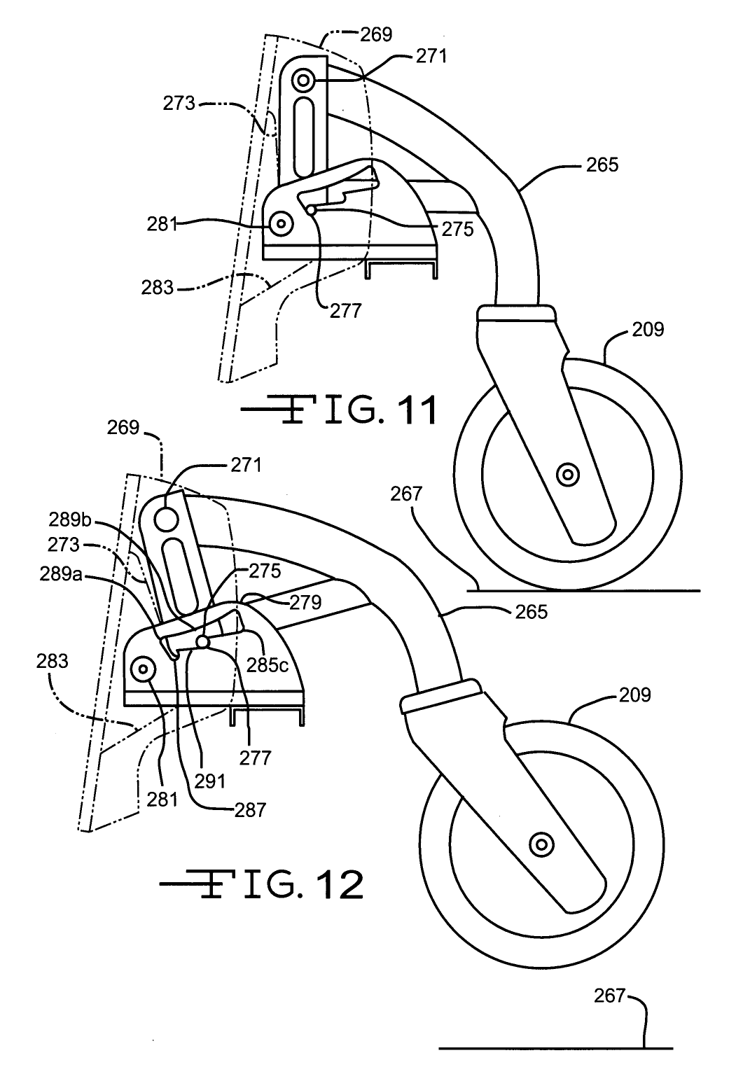

As shown in FIGS. 8-10, a locking mechanism 269 for a rear caster wheel 209 is configured to allow an easy manipulation of a rear caster wheel 209. In the illustrated embodiment, the rear caster wheel 209 is connected the base frame (not shown) of the wheelchair via a caster arm 265. Alternatively, the rear caster wheel 209 can be connected to the base frame by another device or mechanism, such as for example a rear anti-tip cube or block. As shown in FIG. 8, the rear caster arm 265 is in a second position in which the rear caster wheel 209 is in contact with a supporting surface of the wheelchair in the form of ground 267. The rear caster wheel 209 is accordingly in a drive position or is set at ground level. The rear caster wheel 209 is locked in this second position by a locking mechanism 269. The functionality of locking mechanism 269 will be explained below. As shown in FIG. 9, the rear caster wheel 209 can be brought to a first position by locking the caster arm 265 with the locking mechanism 269. In this position, rear caster wheel 209 is lifted a distance above the ground 267. In one embodiment, the distance above the ground can be 5 cm. In another embodiment, the distance can be more or less than 5 cm. The lifting of rear caster wheel 209 a distance above the ground allows the rear caster wheel 209 to override an obstacle, such as for example a road curb, with the wheelchair.

Referring again to FIG. 9, the caster arm 265 and the rear caster wheel 209 are forced into the first position by a first biasing device of the locking mechanism 269. The rear caster wheel 209 is moved from the second position shown in FIG. 8 automatically into the first position shown in FIG. 9 after a lock is released. In another embodiment, the rear caster wheel can be positioned in a third position located between the first and second position. In the third position, the caster arm 265 and the rear caster wheel 209 may be locked by the locking mechanism 269.

In another embodiment as shown in FIG. 10, the wheelchair is configured to override a taller obstacle. In this embodiment, the caster arm 265 and the rear caster wheel 209 are be brought into a fourth position. In the fourth position, the rear caster wheel 209 is lifted a distance above the ground 267. In one embodiment, the distance above the ground can be 12 cm. In another embodiment, the distance above the ground can be more or less than 12 cm. The distance of the rear caster wheel 209 above the ground allows the rear caster wheel 209 to override taller obstacles with the wheelchair or to override stairs with the wheelchair.

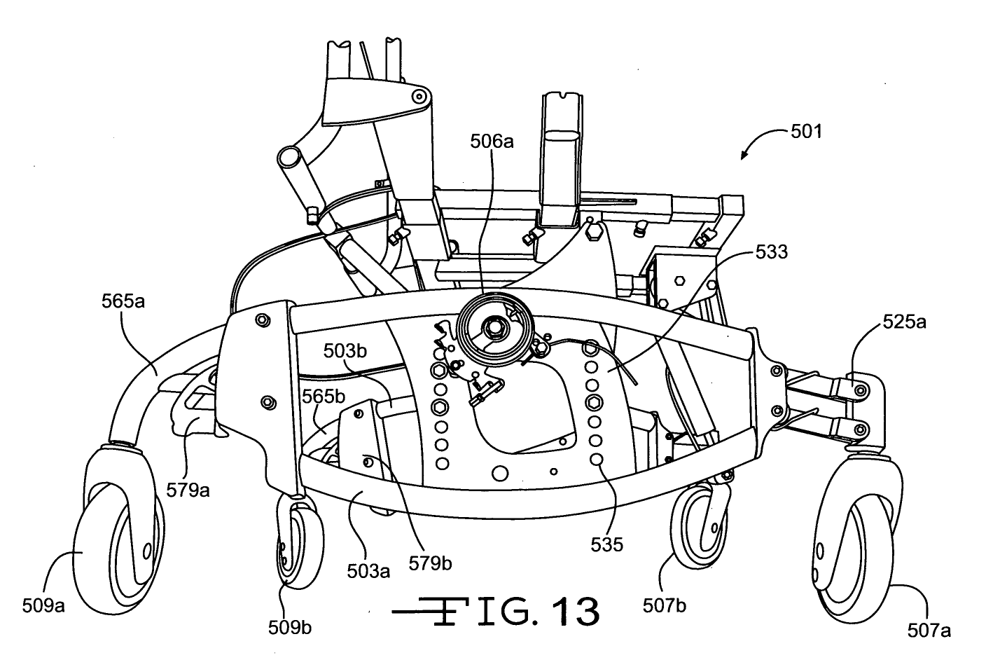

One embodiment of the locking mechanism 269 is shown in FIGS. 11 and 12. The caster arm 265 is pivotable mounted for rotation about a rotating axis 271. The locking mechanism 269 includes a first biasing device 273. In the illustrated embodiment, the first biasing device 273 is a flat spring. In another embodiment, the first biasing device 273 can be other suitable mechanisms or devices. A pin 275 connects the caster arm 265 to the locking mechanism 269. In the illustrated embodiment, the pin 275 is a lock pin. In another embodiment, the pin 275 can be other types of mechanisms or devices, such as for example screws or clips, sufficient to connect the connect the caster arm 265 to the locking mechanism 269. The pin 275 is guided within a slot 277. In the illustrated embodiment, the slot 277 includes notches in which pin 275 can be seated to lock the caster arm 265 in respective positions. Alternatively, the pin 275 can be seated by other devices or mechanisms, such as for example clips or clamps. Slot 277 is formed within a lever 279. The lever 279 is pivotable about a rotating axis 281. The locking mechanism 269 also includes a second biasing device 283. In the illustrated embodiment, the second biasing device is a flat spring. Alternatively, the second biasing device 283 can be other suitable mechanisms or devices. In operation, the second biasing device 283 forces the lever 279 in a direction upward or counter clockwise as best shown in FIG. 12. Accordingly, the pin 275 is forced by the second biasing device 283 into respective notches 285a, 285b or 285c formed within slot 277. Referring again to FIG. 11, the pin 275 is forced into a notch 285a. In one embodiment, the lever 279 can include an extension (not shown). The extension can be configured to allow actuation of the lever 279 by foot. In the illustrated embodiment, the extension can be a pedal. In another embodiment, the extension can be other mechanisms or structures sufficient to allow actuation of the lever 279 by foot.

The operation of the rear caster wheel 209 is best illustrated in FIGS. 11 and 12. FIG. 11 illustrates the caster arm 265 in the second position. In the second position, the caster arm 265 is secured against the force of the first biasing device 273 as the second biasing device 283 forces pin 275 into notch 285a such that pin 275 can not move within slot 277. Due to the special form of notch 285a, the pin 275 can not override an elevation 289a, as best shown in FIG. 12. To transfer the caster arm 265 and the rear caster wheel 209 into the position shown in FIG. 12, lever 279 is actuated. In the illustrated embodiment, lever 279 is actuated by pressing pedal 287 downward.

In another embodiment, the level 279 can be actuated by other suitable devices or mechanisms, such as for example by an electric solenoid. As the pedal 287 is pressed downward, lever 279 is rotated about rotating axis 281 against the force of the second biasing device 283. This allows pin 275 to override the elevation 289a. As pin 275 moves freely within slot 277, caster arm 265 pivots around rotating axis 271. In summary, moving the pedal 287 in a downward direction results in movement of the caster arm 265. In one embodiment, downward movement of the pedal 287 results in an upward movement of the caster arm 265 a distance of about 5 cm. In another embodiment, downward movement of the pedal 287 results in an upward movement of the caster arm 265 a distance of more or less than about 5 cm. This movement is spring loaded as caused by the force of the first biasing device 273. As the force is built up by the second biasing device 283, the lever 279 is forced in an upward direction such that pin 275 is guided along an inclination 291a formed within slot 277. The lever 279 continues to move in an upward direction until the lever 279 reaches notch 285b and is stopped at an elevation 289b. The pin 275 is in the middle of the lock formed by lever 273 and is kept there by the spring loading. In this first position, the rear caster wheel 209 has a distance from the ground 267. In one embodiment, the distance from the ground 267 is about 5 cm. Alternatively, the distance from the ground 267 can be more or less than 5 cm. In another embodiment, additional notches can be formed within slot 277. The additional notches result in defining additional third positions in which caster arm 265 can be locked by locking mechanism 269, the third positions occurring between the first position shown in FIG. 12 and the second position shown in FIG. 11.

In operation, actuating pedal 287 again moves lever 279, thereby releasing pin 275 from the position shown in FIG. 12. The force of the first biasing device 273 causes the caster arm 265 to be pivoted further about rotating axis 271 into a further raised position. In this position, pin 275 is maintained in notch 285c. The rear caster wheel 209 is maintained a distance from ground 267 to allow the wheelchair 1 to override taller objects or to override steps. In one embodiment, the distance from the ground 267 is approximately 12 cm. In another embodiment, the distance from the ground 267 can be more or less than 12 cm.

In an alternative embodiment, the first biasing device 273 is configured to hold rear caster arm 265 in the position shown in FIG. 12. In this embodiment, slot 277 may be formed alternatively, such as for example not having an elevation 289b, but having an inclination towards notch 285c. This embodiment allows a movement of caster arm 265 by manually lifting caster arm 265 into the raised position without the necessity of actuating lever 279 or pedal 287. In this embodiment, a backward moving of pin 275 is prevented by an elevation formed in slot 277 in the region of notch 285c. To release the caster arm 265 from the raised position, lever 279 is actuated such that pin 275 leaves notch 285c.

In the illustrated embodiment, to transfer caster arm 265 from a raised position into the position shown in FIG. 12, caster arm 265 is pressed in a downward direction. Pressing the caster arm 265 in a downward direction causes the pin 275 to leave notch 285c and move toward notch 285b while being guided along an inclination 291b and against the force of the first biasing device 273. A further downward pressing of the caster arm 265 guides the pin 275, via the inclination 291a, into notch 258a. In notch 258a, the pin is locked such that the caster wheel 209 is again in the position shown in FIG. 11. In summary, a pressing in a downward direction, for example stepping on the caster arm 265, will make the pin 275 slip out of position and allows the caster arm 265 to return to the ground 267. In this position, the pin 275 is again in the front position of the locking mechanism 269.

In summary, the construction of a locking mechanism 269 allows movement of the rear caster wheel 209 by actuating lever 279. The actuating lever 279 can be moved by pedal 287 and by pressing the caster arm 265 in a downward direction. Accordingly, the relative position of the rear caster wheel 209 with respect to a ground level 267 may be adjusted simply by one actuation action. In one embodiment described above, a person operating the wheelchair 1 may only have to lower a foot to operate pedal 287 or to lower the caster arm 265 or by lifting a foot to raise rear caster wheel 209 such that the caster arm 265 is locked in the wanted position by locking mechanism 269. In yet another embodiment, the rear caster wheel 209 can be maintained in the required position by the use of suitable mechanisms or devices, such as for example clamping bolts, chain, or pins. While the preceding description of the locking mechanism 269 provides only for the unlocking of one rear caster wheel 209, it should be understood that in an alternative embodiment, the locking mechanisms of each rear caster wheel 209 may be coupled. For example, in one embodiment, levers or pedals can be connected such that an actuation of a lever or pedal of one locking mechanism leads to an unlocking of both rear caster wheels so that they are automatically lifted in an upward direction. In another embodiment, the caster arms of at least two rear caster wheels can be connected such that slipping on one rear caster arm leads to movement of both rear caster wheels.

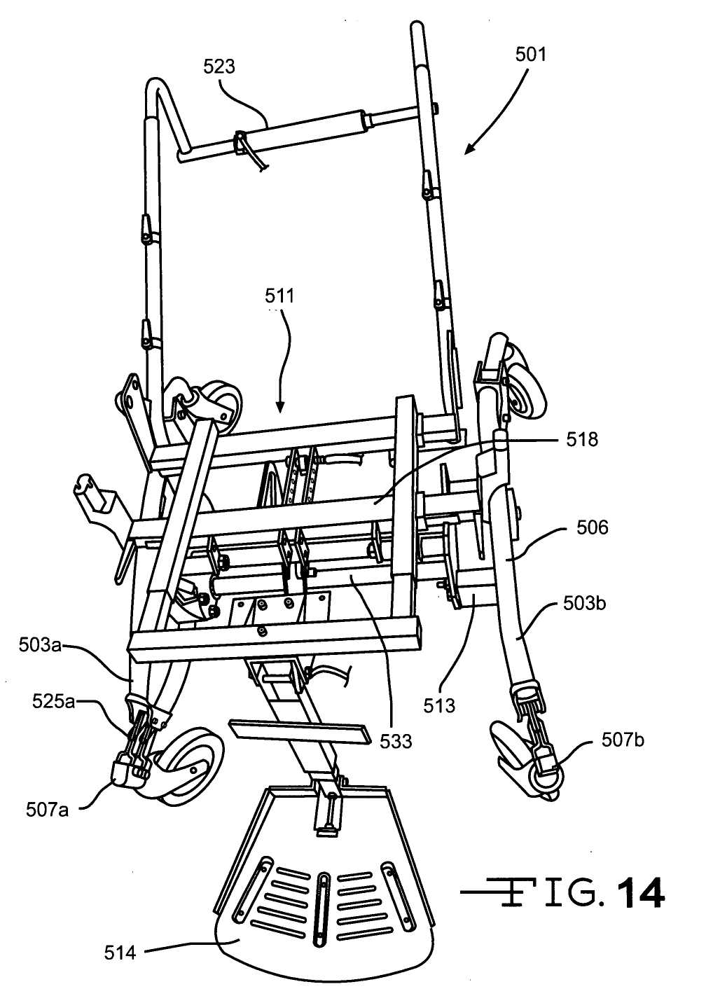

In another embodiment of the wheelchair, the wheelchair can be adapted to the needs of a user. One example of adapting a wheelchair is to adapt a wheelchair to a width of a seat with respect to the constitution of the person using the wheelchair. It is common in the construction of wheelchairs to adapt the entire wheelchair to adapt to the width of a user. As illustrated in FIGS. 13 and 14, the wheelchair 501 in this embodiment is constructed of predefined modular elements. In this embodiment, elements of wheelchair 501 corresponding to respective elements of wheelchair 1 have the same reference numbers, but increased by 500. The wheelchair 501 includes base frame members 503a and 503b. The base frame members 503a and 503b include suspension systems 525a and 525b. The suspension systems 525a and 525b connect front caster wheels 507a and 507b to the base frame members 503a and 503b. The base frame members 503a and 503b include caster arms 565a and 565b. The caster arms 565a and 565b connect the rear caster wheels 509a and 509b to the base frame members 503a and 503b. The caster arms 565a and 565b also include locking mechanisms 579a and 579b. The primary support wheels (not shown) are connected to base frame members 503a and 503b at receptacles 506a and 506b. The base frame members 503a and 503b are connected to a seat carrying frame 511. The seat carrying frame 511 includes a handle 521 for maneuvering of the wheelchair, a foot rest 514 and a tilt frame 513.

The tilt frame 513 can be connected to different seats having different seat widths. In commonly available wheelchairs, the use of a wider seat makes the adaptation of a self carrying base frame necessary to increase the distance between primary support wheels to avoid a contact of the seat with the wheels. In the illustrated embodiment, it is not necessary to change the base frame elements of wheelchair 501 when using seats of different widths. As the base frame members 503a and 503b are independent from each other and not connected to each other via the seat carrying frame 511, the base frame members 503a and 503b can be used for different seat widths. To adapt the base frame to a different seat width, the base frame members 503a and 503b can be connected to the seat carrying frame 511 via a plurality of interchangeable spacers 518. As shown in FIG. 14, the spacers 518 are positioned on each side of the base frame members 3a and 3b, with one group of spacers 518 located in a forward position and another group of spacers 518 located in a rearward position. The spacers 518 can be ganged together to have a pre-selected width corresponding to a desired seat width. In one embodiment, each spacer 518 has a width of about 2.5 cm. Alternatively, each spacer 518 can have other widths. In the illustrated embodiment, the spacers 518 have a length of about 110 mm and a height of about 30 mm. In another embodiment, the length of the spacers 518 can be more or less than 110 mm and the height can be more or less than 30 mm. In the illustrated embodiment, three spacers 518 are ganged together to form a width of about 7.5 cm. In another embodiment, more or less than three spacers 518 can be ganged together. The spacers 518 have a plurality of apertures (not shown) corresponding to the apertures in the tilt frame plate 533. Accordingly, the same seat carrying frame 511 and the same base frame members 503a and 503b can be used for different seats and an easy adaptation of the wheelchair to different seats is possible. Additionally, it is not necessary to stock different base frames for different seats having different widths. Therefore, the modular construction of the wheelchair 501 shown in FIGS. 21 and 22 allows the production costs of the wheelchair 501 to be reduced significantly.

In another embodiment, the base frame members may be adjustable in length. Adjusting the length of the base frame members allows for an adaptation of the position of rear caster wheels and/or front caster wheels when seats of different seat depths are used.

In another alternative embodiment the seat frame members are connected to the seat carrying frame at a front and rearward side of the seat carrying frame with regard to a seating direction instead of being arranged at a right and a left side. This embodiment allows one of the base frame members to carry at least a pair of wheels like front caster, rear caster or primary support wheels. By connecting the base frame member to the seat carrying frame via spacers having different lengths, the position of the respective wheels with regard to the seat carrying frame may be adapted making possible an adaptation to different seat depths of the used seat. In this embodiment, a pair of primary support wheels can be located in the middle of the wheelchair and/or that the center of gravity of an occupant is located in the area of an axle of the primary support wheels. Accordingly, the wheelchair has good maneuverability, without further constructional provisions, although seats of different seating depths are used.

The principle and mode of operation of this invention have been described in its preferred embodiments. However, it should be noted that this invention may be practiced otherwise than as specifically illustrated and described without departing from its scope.

What is claimed is:

1. A wheelchair having a two-stage tilt ability, the wheelchair comprising:
a base frame;
a seat mounted to the base frame, the seat configured for rearward tilting; and
a mounting mechanism connected to the seat, the mounting mechanism configured to tilt the seat by a first pivoting of the seat through a first range of tilting about a first pivot axis, and a second pivoting of the seat through a second range of tilting about a second pivot axis.

2. The wheelchair of claim 1, in which the mounting mechanism includes a first actuation member configured to actuate the tilt of the seat through a first range of tilting, and a second actuation member configured to actuate the tilt of the seat through a second range of tilting.

3. The wheelchair of claim 2, in which the second actuation member is connected to the mounting mechanism by at least one extension.

4. The wheelchair claim 2, in which the first actuation member is only operable when the second actuation member is in at least one predetermined first operating condition, and the second actuation member is only operable when the first actuation member is in at least one predetermined second operating condition.

5. The wheelchair of claim 1, in which the first pivot axis is positioned forward of the second pivot axis with respect to a direction of seating of an occupant of the wheelchair.

6. The wheelchair of claim 1, in which the mounting mechanism is configured so that the position of the second pivot axis with respect to the base frame is alterable.

7. The wheelchair of claim 1, in which the mounting mechanism includes at least one tilt frame plate, wherein the tilt frame plate is detachably attached to the base frame to enable a position of the mounting mechanism with respect to the base frame to be altered.

8. The wheelchair of claim 1, in which the seat includes at least one backrest pivotable about at least one third pivot axis, wherein the pivoting of the backrest is actuated by at least one third actuation member.

9. The wheelchair of claim 1, in which the seat has an adjustable height with respect to a support surface, wherein the seat height is adjustable by altering the mounting mechanism.

10. The wheelchair of claim 1, in which the first range of tilting is from about 0 to about 30 degrees, and the second range of tilting is from about 30 degrees to about 50 degrees.

11. A method for tilting a seat of a wheelchair, wherein the method includes a first pivoting of the seat through a first range of tilting, the first pivoting being about a first pivot point, and a second pivoting of the seat through a second range of tilting, the second tilting being about a second pivot point.

12. The method of claim 11, in which the wheelchair includes a mounting mechanism, wherein the mounting mechanism includes at least one first actuation member configured to actuate the tilt of the seat through a first range of tilting, and at least one second actuation member configured to actuate the tilt of the seat through a second range of tilting.

13. The method of claim 12, in which the first actuation member is only operable when the second actuation member is in at least one predetermined first operating condition, and the second actuation member is only operable when the first actuation member is in at least one predetermined second operating condition.

14. The wheelchair of claim 11, in which the first range of tilting is from about 0 to about 30 degrees, and the second range of tilting is from about 30 degrees to about 50 degrees.

15. A wheelchair comprising:
a base frame;
a seat mounted to the base frame;
one or more rear caster wheels, wherein the rear caster wheels are supported by at least one caster arm, the caster arm configured to move with respect to the base frame, and;
a locking mechanism configured to adjustably secure the caster arm in a desired position, wherein each position of the caster arm maintains the rear caster wheel at a specified position relative to a supporting surface of the wheelchair, wherein the locking mechanism comprises at least one first biasing device configured to force the caster arm into at least one first position.

16. The wheelchair of claim 15, in which the rear caster wheel is forced away from the supporting surface of the wheelchair by the first biasing device.

17. The wheelchair of claim 15, in which the locking mechanism includes at least one actuation device configured to release the caster arm from at least one second position, wherein the caster arm is driven by the first biasing device into the direction of the first position.

18. The wheelchair of claim 17, in which the actuation device is operable by the foot of a user of the wheelchair.

19. The wheelchair of claim 15, in which the caster arm is securable by the locking mechanism in at least one third position located between the first and the second position, wherein the caster arm can be released from the third position by actuating the actuation device, wherein the caster arm is driven by the first biasing device, into the direction of the first position.

20. The wheelchair of claim 15, in which the locking mechanism includes at least one pin connected to the caster arm, wherein the pin is movable within a slot, wherein the slot is in form of at least one slotted link.

21. The wheelchair of claim 20, in which the slot includes at least one notch configured to seat the pin in a specific position, wherein the position of each notch corresponds to a position of the caster arm, wherein the at least one notch determines the distance of the rear caster wheel off the supporting surface.

22. The wheelchair of claim 21, in which at least one second biasing device forces and/or maintains the pin in at least one notch.

23. The wheelchair of claim 21, in which the slot includes at least one inclination configured to guide the pin into at least one notch.

24. The wheelchair of claim 18, in which the actuation device comprises at least one lever, wherein by actuating the lever, the pin is released either from at least one notch or is guided into at least one notch, or both released from the notch and guided into the notch.

25. The wheelchair of claim 24, in which the caster arm and the lever are pivotally mounted with respect to the base frame, wherein the caster arm is pivotable about a first rotating axis and the lever is pivotally mounted about a second rotating axis.

26. A wheelchair having a base frame comprising at least one drive device and at least one seat carrying frame, wherein the base frame comprises at least one pair of separate base frame members mounted at opposite sides to the seat carrying frame, wherein each of the base frame members is detachably mounted via at least one interchangeable spacer to the seat carrying frame.

27. The wheelchair of claim 26, in which at least one dimension of the spacer is adjustable.

28. The wheelchair of claim 27, in which the spacers, being configured for various sizes, provide for the use of varying size seats.

29. The wheelchair of claim 28, in which at least one dimension of the spacer and at least one horizontal position of the base frame is adapted to position a center of gravity of an occupant of the wheelchair to be substantially coincident with the position of at least one drive device.
